(19) United States
(12) Patent Application Publication
(10) Pub. No.: US 2026/0330914 A1
(43) Pub. Date: Oct. 22, 2026

(54) AUTOMATIC VENDING DEVICE AND METHOD FOR NAIL ART TREATMENT

(71) Applicant: NAILTOCTOC., LTD., Gwangju (KR)

(72) Inventor: Jang Yong JOO, Gyeonggi-do (KR)

(21) Appl. No.: 19/104,789

(22) PCT Filed: Aug. 23, 2023
(86) PCT No.: PCT/KR2023/012462

§ 371 Date: Feb. 19, 2025

(30) Foreign Application Priority Data
Aug. 25, 2022 (KR) 10-2022-0107039

(51) Int. Cl. G07F 17/26; A45D 29/00; A45D 29/22; B41J 3/407; B41J 11/00; G07F 17/04

(52) U.S. Cl. CPC G07F 17/266; A45D 29/001; A45D 29/22; B41J 3/40731; B41J 11/00214; G07F 17/04; A45D 2029/005

(57) ABSTRACT

The invention relates to an automatic vending device and method for nail art treatment. The disclosed device and method accurately and automatically measure the shape, size, and position of nails using nail recognition means. Designs provided through a website or mobile platform, or images created by the user, are aligned to the target nail areas. Nail art is then printed using UV ink that is harmless to humans, providing users with an enjoyable and aesthetically pleasing nail art experience that is easy, fast, and cost-effective.

### TECHNICAL FIELD

The present invention relates to an automatic vending device and method for nail art treatment. More specifically, it pertains to a system that enables the application of pre-designed or user-created nail art designs onto the nails of a user (consumer) using a UV printer and automated means. Alternatively, the invention allows for printing nail art designs onto nail stickers or nail tips (artificial nails) to be attached to nails, thus providing both entertainment and economic value.

### BACKGROUND TECHNOLOGY OF THE INVENTION

In general, as interest in beauty and personal care has significantly increased, there has been a growing interest in the aesthetic treatment of fingernails and toenails. Nail beauty treatment, commonly referred to as “nail art,” involves not only grooming the area around the nails and applying nail polish but also creating artistic expressions on the nails. This may include painting designs on long nails or attaching decorative elements such as beads or gemstones. Various devices for such nail beauty treatments have been disclosed in Patent Documents 1 to 3.

Patent Document 1 describes a nail art device in which the contour of a nail is recognized by a contour recognition means, and the ridges and grooves (unevenness) are identified by an unevenness recognition means. The nail's shape is then three-dimensionally analyzed and displayed through a three-dimensional display means. After confirming the synthesized information generated by the three-dimensional display means for a selected design or a user-drawn pattern input through a coordinate input device, the design is printed onto the nail using a printing means.

Patent Document 2 describes a nail art treatment device that applies ink to a plate surface with recessed portions, transfers the ink present in the recessed portions to a pad, and then retransfers the ink from the pad onto the nail. The device includes the following components:

Finger Tip Fixing Means: A mechanism to secure the fingertip of the person undergoing the treatment.

Plate Selection Means: A mechanism for selecting a plate to use from among multiple plate surfaces.

Plate Transfer Means: A mechanism that moves the selected plate across the working plane.

Ink Dropping Means: A mechanism that selects ink from multiple ink containers and drops the selected ink near the plate being transferred by the plate transfer means.

Ink Application Means: A mechanism that applies the dropped ink onto the plate surface.

Printing Means: A mechanism that transfers the ink applied to the plate onto the pad, and subsequently retransfers it from the pad to the nail of the person undergoing the treatment, whose fingertip is secured by the finger tip fixing means.

This process enables precise printing of designs onto the nail.

Patent Document 3 describes a nail art device or system, either integrated or composed of multiple components, that includes a variety of nail art patterns and a nail art control program. The system comprises the following components:

Control Device: Equipped with various nail art patterns and a control program, it manages the entire process.

Printing Device: Connected to the control device, this prints the nail art pattern selected by the user onto the nail.

Display Device: Controlled by the control device, it displays menus and art patterns on a screen.

The system is housed within a nail art device (main unit) and includes:

Contact Section: Located inside the main unit, this detects the insertion of a user's finger and its contact with a fingerprint sensor.

Cameras: At least one camera is positioned to capture an image of the user's nail from the opposite side once the fingerprint sensor detects contact.

Image Acquisition Device: Captures specific patterns provided by the user within the identified nail region from the camera's footage and acquires image data of these patterns.

Storage Unit: Stores the image data edited by the control unit, which is acquired through the image acquisition device.

### Control Unit:

Displays the nail image captured by the camera.

Identifies the specific nail region where the selected pattern is to be printed.

Displays the specific pattern's image data obtained through the image acquisition device on the display device.

Edits and stores the pattern image data in the storage unit.

Arranges the edited image data within the identified nail region to enable printing.

This system integrates advanced recognition, customization, and printing capabilities for precise and personalized nail art application.

However, nail beauty devices like those described in the prior art face significant limitations. These devices do not allow users to directly implement diverse designs or intricate images, which can lead to users losing interest in nail beauty treatments.

Specifically, conventional nail beauty devices rely solely on pre-stored images within the device for performing nail art. This not only diminishes the entertainment value for users but also restricts the scope of beauty treatments to a limited range. As a result, these devices fail to deliver aesthetically pleasing and diverse nail art designs.

Therefore, there is an urgent need to develop an automatic vending device for nail art treatment that enables users to perform nail beauty treatments with a wide variety of designs tailored to their preferences, achieving both aesthetic appeal and economic efficiency.

### PRIOR ART REFERENCES

### Patent Documents

(Patent Document 1) KR Korean Published Patent No. 10-2000-0075428
(Patent Document 2) KR Korean Published Patent No. 10-2004-0060776
(Patent Document 3) KR Korean Published Patent No. 10-2011-0125967

### CONTENT OF THE INVENTION

### Problems to Be Solved

The present invention has been devised to address the aforementioned issues in conventional technologies. The primary objective of this invention is to provide an automatic vending device and method for nail art treatment that enables precise and automatic measurement of the shape, size, and position of the nail using a nail measurement means. This device allows the direct synthesis of a given design or a consumer-created image onto the designated nail region and prints it using UV ink that is harmless to the human body. This approach offers users the enjoyment and beauty of nail art while being convenient, quick, and cost-effective.

Additionally, another objective of the present invention is to offer a nail art vending device and method that allows for the printing of desired designs onto nail tips or nail stickers for nail art instead of directly applying them to the user's nails. This enables users to easily attach the printed nail tips or stickers to their nails, realizing nail art in a simple and efficient manner.

### Means for Solving the Problem

The automatic vending device for nail art treatment of the present invention, designed to achieve the aforementioned objectives, comprises the following components:

### Casing Main Body:

Equipped with a hand insertion port that allows the user to directly insert their hand for applying nail art to the nails.

Features an output port for dispensing printed nail tips or nail stickers intended for attachment to the user's nails instead of direct application.

### Finger Fixture:

Positioned inside the casing main body, aligned with the hand insertion port. Provides a support mechanism for directly securing the user's fingers inserted through the hand insertion port.

### Nail Measurement Means:

Installed inside the casing main body, above the finger fixture.

Captures image data of each nail when the user's fingers are secured in the finger fixture.

Extracts nail image data for further processing.

### Nail Art Printing Means:

Utilizes the synthesized nail art image data provided by the nail measurement means.

Prints the nail art directly onto the user's nails or onto nail tips or nail stickers designed for later attachment to the user's nails.

### Loading Means:

Configured to load either the user's fingers secured in the finger fixture for direct nail art printing or nail tips/nail stickers for indirect application.

Allows flexible operation for printing nail art designs directly onto nails or onto auxiliary materials like nail tips or stickers.

This configuration enables both direct application of nail art designs to the user's nails and the creation of pre-designed nail art tips or stickers for attachment, providing a versatile and efficient nail art solution.

The loading means in the present invention includes the following components to enable flexible and precise operation of the nail art printing process:

### Finger Rest Loading Means:

Configured to load a finger rest attached to the finger fixture so that the nail portion of the user's finger, secured by the finger fixture, is positioned beneath the nail art printing means.

Allows the nail art printing means to directly apply designs to the user's nails.

### Nail Tip Loading Means:

Designed to supply nail tips stacked inside the casing main body to the position beneath the nail art printing means.

Enables the printing of nail art designs onto nail tips for later attachment to the user's nails.

### Nail Sticker Loading Means:

Configured to sequentially supply nail stickers stacked inside the casing main body to the position beneath the nail art printing means.

Allows for printing designs onto nail stickers intended for attachment to the user's nails.

### Operational Selection:

Only one of the loading means—finger rest loading means, nail tip loading means, or nail sticker loading means—is selected at a time. This ensures that either the user's nails, nail tips, or nail stickers are loaded beneath the nail art printing means for processing.

This design enables the device to:

Directly apply nail art designs to the user's nails.

Print designs onto nail tips or nail stickers for subsequent attachment to the nails. This versatility ensures high adaptability and efficiency in delivering customized nail art solutions.
The finger rest loading means preferably includes air cylinders installed on both sides of the finger rest. These air cylinders are configured to position the finger rest, which is part of the finger fixture, beneath the nail art printing means.
This setup ensures precise and stable movement of the finger rest, allowing accurate alignment of the user's nails with the printing mechanism. The use of air cylinders also enhances the system's durability, control, and reliability during operation, contributing to the overall efficiency of the nail art treatment process.

The nail tip loading means is preferably composed of the following components to ensure efficient and precise delivery of nail tips to the nail art printing means:

### Loader Unit:

Installed beneath the nail art printing means with the capability to move vertically (up and down).

Responsible for positioning nail tips within the printing area.

### Nail Tip Transfer Unit:

Equipped with a conveyor belt adjacent to the lower position of the loader unit. Transports nail tips supplied by the conveyor belt toward the loader unit.

### Nail Tip Stacking Unit:

Multiple stacking areas are located on both sides of the conveyor belt.

Holds stacks of nail tips ready for sequential processing.

### Nail Tip Supply Unit:

Feeds nail tips sequentially from the nail tip stacking unit to the conveyor belt, starting from the bottom of the stack.

### Suction Pad:

Absorbs nail tips using air pressure from the conveyor belt and lifts them.

Places the nail tips onto the loader unit.

Moves up and down and reciprocates between the conveyor belt and loader unit to transfer nail tips effectively.

### Nail Tip Transport Unit:

Facilitates the movement of the suction pad for transferring nail tips from the conveyor belt to the loader unit.

### Loader Unit Configuration:

The loader unit is vertically adjustable to raise or lower nail tips brought by the nail tip transport unit.

Includes a lifting plate with a rotational axis at the rear. This plate is configured to rotate at a specified angle, allowing printed nail tips to be discharged through the output port of the casing main body.

### Nail Tip Upper Support Member:

Installed beneath the nail art printing means at a set distance above the lifting plate.

Supports the upper edges of nail tips during the printing process.

Adjusts vertically along with the lifting plate, ensuring stability and precision during printing.

This comprehensive configuration allows seamless handling, positioning, and printing of nail tips, ensuring that printed nail tips can be discharged efficiently through the output port after processing. It also ensures precise alignment and support of the nail tips during the printing process, contributing to high-quality nail art production.

The nail sticker loading means is designed for precise and efficient handling of nail stickers during the nail art printing process. It includes the following components:

### Loader Unit:

Installed beneath the nail art printing means with the ability to move vertically (up and down).

Supports and adjusts the position of the nail sticker during printing.

### Nail Sticker Stacking Unit:

Located at the upper rear of the loader unit.

Holds a stack of nail stickers ready for sequential processing.

### Nail Sticker Supply Unit:

Sequentially supplies nail stickers from the bottom of the stack in the nail sticker stacking unit.

### Nail Sticker Support Plate:

A plate on which nail stickers are placed as they are supplied by the nail sticker supply unit.

Hinged with a rotational axis at the rear, allowing it to rotate by a specified angle.

Maintains a horizontal position during printing by the nail art printing means to ensure accuracy and stability.

### Loader Unit Configuration:

Supports the underside of the nail sticker support plate and is vertically adjustable.

Includes a lifting plate that works in tandem with the nail sticker support plate.

The lifting plate is attached to a rotational axis at the rear, allowing it to rotate by a specified angle.

This mechanism enables the printed nail stickers to be discharged through the output port of the casing main body after printing.

### Operation:

The nail sticker supply unit feeds nail stickers onto the nail sticker support plate, ensuring proper alignment.

The loader unit raises or lowers the nail sticker to the appropriate height for printing.

After printing, the lifting plate rotates with the nail sticker support plate to guide the printed nail sticker to the output port for discharge.

This configuration ensures precise positioning, stability, and smooth operation for high-quality printing on nail stickers, while facilitating efficient discharge after processing.

It is preferable that vacuum suction holes are formed on the nail sticker support plate to allow the nail stickers to be adsorbed and supported by vacuum pressure.

The finger fixture includes:

A finger rest with multiple finger rest grooves formed to individually accommodate the fingers of the person undergoing the treatment.

A tube-type finger stabilizer installed in the finger rest grooves, which expands with air pressure to hold the fingers in place within the grooves without allowing movement.

A support cover installed to cover the top of the finger rest, preventing the fingers placed in the grooves from touching the nozzle area of the nail art printing means. The support cover includes open slots corresponding to the grooves, which expose the nails of the fingers to the nozzle area of the nail art printing means.

This configuration ensures stability and precise alignment during the nail art printing process.

The nail measurement means is configured with a camera installed above the finger fixture and multiple lighting lamps.

When the camera captures and recognizes the nail, it is preferable to arrange the lighting lamps in different positions and operate them sequentially to avoid difficulties in accurately recognizing the boundary between the hand and the nail caused by shadows from the lighting lamps.

The nail measurement means is equipped with a nail art image synthesis program developed using an Al algorithm.

This nail art image synthesis program preferably selects the image most similar to the nail image extracted by the nail photographing means from a pre-input database of nail images using the Al algorithm. It then synthesizes the nail art image to be directly applied to the nail.

The nail art printing means uses UV ink with varying wavelengths of UV light, including color ink, white ink, and varnish.

It is preferable that printing is performed at least three times on the nail tip, nail sticker, or the nail of the person undergoing the treatment. Each ink emits UV light with the required wavelength for curing, enabling the ink to solidify properly.

When the printing surface is curved, it is desirable to adjust the printer's movement speed. Specifically, the speed should be slower at the sides of the curved area than at the central part of the curve. This ensures that the curved surface's sides receive a greater amount of ink, resulting in uniform application across the curved area.

Additionally, to achieve the objectives, the automatic vending method for nail art treatment of the present invention includes the following steps:

### Finger Placement Step:

The user's fingers for nail art application are directly placed onto the finger fixture through the hand insertion port provided in the casing main body.

### Nail Measurement Step:

When the user's fingers are placed on the finger fixture, the nail measurement means captures the nail areas of the user's fingers to extract image data for each nail.

### Loading Step:

Based on the nail art synthesis image data provided by the nail measurement step:

The finger fixture is loaded to apply nail art directly to the user's nails.

Alternatively, nail tips or nail stickers designed for attachment to the user's nails, instead of direct application, are loaded.

### Printing Step:

The nail art printing means prints the synthesized nail art image data, provided by the nail measurement means, directly onto the user's nails.

Alternatively, selected nail art image data is printed onto the surfaces of the nail tips or nail stickers supplied during the loading step.

This method enables the efficient application of nail art, whether directly to the user's nails or indirectly via nail tips or stickers, ensuring versatility and precision in the nail art process.

The nail measurement step includes the following sub-steps:

### Step 1: Scanning

Scanning the fingers of the user placed on the finger fixture using a 3D scanner.

### Step 2: Image Capturing

After completing the scan, capturing the user's hand images using the nail measurement means.

### Step 3: Background Removal and Finger Area Extraction

Removing the background from the captured images and extracting the finger areas using algorithms and guides.

### Step 4: Nail Position Information Extraction

Extracting position information of the nails from the identified finger areas.

### Step 5: Candidate Nail Area Setting

Setting candidate areas for nail art application based on the extracted nail position information.

### Step 6: Nail Art Image Alignment

Aligning the user-selected, pre-stored image or a user-created nail art image to the candidate nail area using the nail position information.

Once the alignment is complete, the selected nail art image data is sent to the nail art printing means, which:

Prints the image directly onto the candidate areas of the user's nails.

Alternatively, prints the image onto nail tips or nail stickers for subsequent attachment to the nails.

This multi-step process ensures precise alignment of nail art designs with the user's nails or other mediums, enhancing the quality and personalization of the application.

In Step 1, scanning with a 3D scanner is preferably executed through 3D mesh generation, error correction of the generated mesh, and Z-value scale adjustment.

In Step 4, extracting nail position information, and in Step 5, setting candidate nail areas, it is preferable to select a group of candidate nails through area matching in the hand image database, followed by noise removal, model selection and training, evaluation through cross-validation, and detailed tuning of the model to extract nail position information.

In Step 6, image alignment for candidate nail areas is preferably executed by selecting the image most similar to the one extracted from the user's nail using an Al algorithm with a nail art image synthesis program. This program matches the extracted image to pre-input nail images in the database and synthesizes the nail art image to be directly applied to the nail.

The loading step includes:

### Finger Rest Loading Step:

Loading the finger rest equipped with the finger fixture so that the nail portion of the finger placed on the finger fixture is positioned beneath the nail art printing means, allowing direct printing on the nail of the person undergoing the treatment.

### Nail Tip Loading Step:

Supplying nail tips stacked inside the casing body to the position beneath the nail art printing means, enabling printing on nail tips intended for attachment to the user's nails.

### Nail Sticker Loading Step:

Sequentially supplying nail stickers stacked inside the casing body to the position beneath the nail art printing means, enabling printing on nail stickers intended for attachment to the user's nails.

It is preferable to perform only one selected step among the finger rest loading step, nail tip loading step, or nail sticker loading step, so that in the printing step, nail art is either directly applied to the user's nails or printed on nail tips or nail stickers for attachment.

### Effects of the Invention

According to the automatic vending device and method for nail art treatment of the present invention, there is an effect of providing consumers with the enjoyment and beauty of nail art conveniently, easily, quickly, and at a low cost by allowing a given design or a user-created image to be synthesized onto the nail area and precisely printed onto the target nail.

Additionally, the present invention enables users to freely select and print desired designs on nail tips or nail stickers for nail art, which can be naturally attached to the user's nails instead of direct application, thereby achieving a versatile and user-friendly solution.

### BRIEF DESCRIPTION OF DRAWINGS

FIGS. 1(a), (b), and (c): External views of the automatic vending device for nail art treatment according to the present invention, showing the front, side, and overall appearance, respectively.

FIGS. 2(a) and (b): Internal views of the automatic vending device for nail art treatment according to the present invention, viewed from the front and rear, respectively.

FIG. 3: An exploded view showing the main components inside the automatic vending device for nail art treatment according to the present invention.

FIG. 4: A front view of FIG. 3.

FIGS. 5(a), (b), (c), and (d): Views of the finger fixture of the automatic vending device for nail art treatment according to the present invention, showing its external appearance and operational states.

FIG. 6: A schematic view showing ink being directly printed onto the nails of a user's finger positioned in the finger fixture of FIG. 5.

FIG. 7: A usage example of the nail measurement means included in the automatic vending device for nail art treatment according to the present invention.

FIGS. 8(a) and (b): Schematic views showing the direction of ink spray onto the user's nail by the nail art printing means of the automatic vending device for nail art treatment according to the present invention.

FIG. 9: A diagram illustrating UV LED wavelength control in the automatic vending device for nail art treatment according to the present invention.

FIG. 10A to FIG. 10L: Sequential diagrams showing the operation process of the nail tip loading means included in the automatic vending device for nail art treatment according to the present invention:

FIG. 10A: A top view showing nail tips loaded in multiple nail tip stacking units of the nail tip loading means.

FIG. 10B: A top view showing nail tips loaded only in the lower nail tip stacking unit of FIG. 10A.

FIG. 10C: A photo showing the nail tip stacking unit with loaded nail tips as shown in FIG. 10B.

FIG. 10D: A top view showing nail tips being transferred to the conveyor belt from the nail tip stacking unit in FIG. 10B.

FIG. 10E: A photo showing the state of nail tips being transferred to the conveyor belt, as shown in FIG. 10D.

FIG. 10F: A photo showing the motor and ball screw used for transferring nail tips from the stacking unit to the conveyor belt, as shown in FIG. 10D.

FIG. 10G: A top view showing the nail tips being transferred toward the loading unit by the conveyor belt.

FIG. 10H: A photo showing the state of nail tips being transferred toward the loading unit by the conveyor belt, as shown in FIG. 10G.

FIG. 10I: A top view showing nail tips being transported to the loading unit by the nail tip transport unit.

FIG. 10J: A photo showing the nail tips transported to the loading unit, as shown in FIG. 10I.

FIG. 10K: A front view of nail tips transported to the loading unit, as shown in FIG. 10I.

FIG. 10L: A view showing the raised state of the loading unit in FIG. 10K.

FIG. 11a and FIG. 11b: Diagrams showing only the loading unit and upper support member of the nail tip loading means included in the automatic vending device for nail art treatment according to the present invention.

FIGS. 12(a), (b), and (c): Diagrams showing the nail sticker loading means included in the automatic vending device for nail art treatment according to the present invention.

FIG. 13a and FIG. 13b: Photos showing the nail sticker loading means from above in the automatic vending device for nail art treatment according to the present invention.

FIG. 14: A block diagram of the automatic vending method for nail art treatment according to the present invention.

FIG. 15: A block diagram of the loading step as shown in FIG. 14.

FIG. 16: A block diagram of the automatic vending method for nail art treatment according to the present invention.

FIG. 17: A process flow diagram showing the steps for applying desired patterns or designs to the user's nails using the automatic vending device for nail art treatment according to the present invention.

### DETAILED DESCRIPTION OF THE INVENTION FOR IMPLEMENTATION

Hereinafter, preferred embodiments of the present invention will be described in more detail with reference to the accompanying drawings.

Prior to the description of the present invention, the following specific structural or functional descriptions are merely provided as examples for explaining the embodiments according to the concept of the present invention. The embodiments according to the concept of the present invention may be implemented in various forms and should not be construed as being limited to the examples described in this specification.

Furthermore, the embodiments according to the concept of the present invention may undergo various modifications and take diverse forms. Specific embodiments are illustrated in the drawings and described in detail in this specification.

However, these are not intended to limit the embodiments of the present invention to specific disclosed forms but should be understood to include all modifications, equivalents, or substitutes falling within the spirit and scope of the present invention.

Additionally, the components of the present invention should be interpreted to include not only direct contact or connection but also contact or connection made through other components between structures.

The automatic vending device for nail art treatment according to the present invention preferably includes a casing main body (110), finger fixture (200), nail measurement means (300), nail art printing means (400), and loading means.

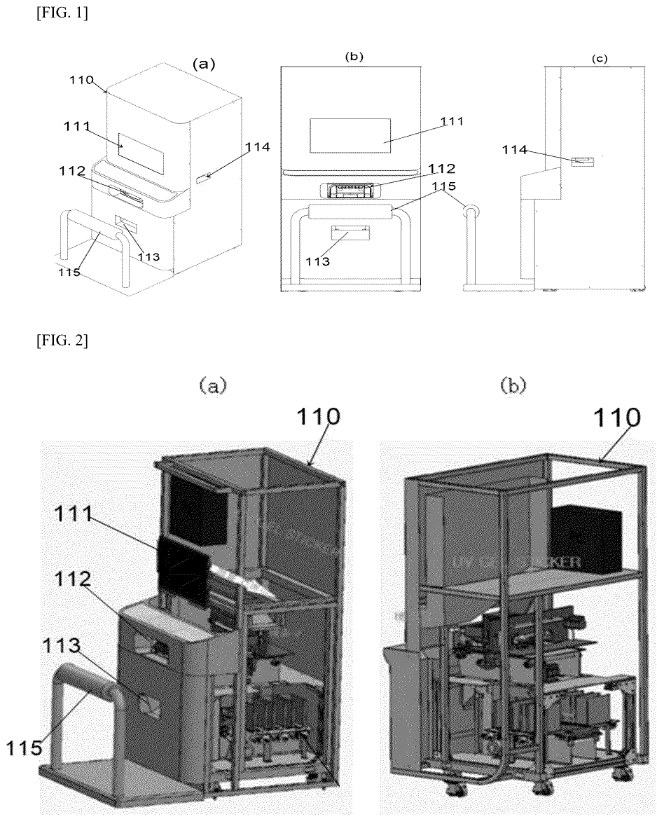

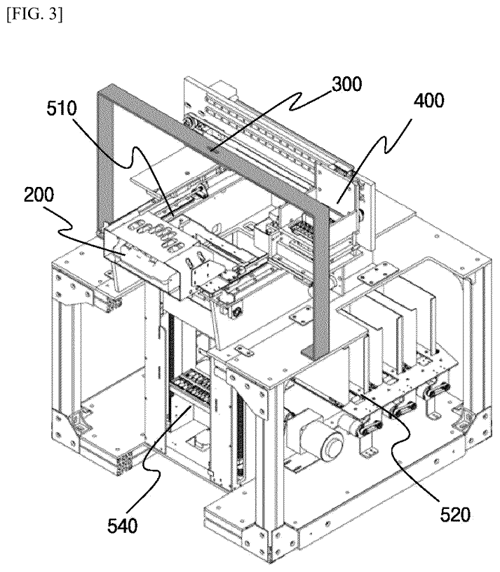

The attached FIGS. 1(a), (b), and (c) show the external appearance, front, and side views of the automatic vending device for nail art treatment according to the present invention, respectively. FIGS. 2(a) and (b) show internal views of the device from the front and rear, respectively.

As shown in the figures, the casing main body (110) is approximately rectangular and vertically installed from the base. The front of the casing is preferably equipped with:

A display window (111), made of a conventional monitor.

A hand insertion port (112), formed to allow the user to directly insert their hand for applying nail art directly to their nails.

An output port (113), formed to discharge printed nail tips (12) or nail stickers (14) when the user selects operations for nail tips or nail stickers instead of direct application to their nails. The output port enables the printed nail tips (12) or nail stickers (14) to be ejected after the printing process.

Additionally, it is preferable that one side of the casing main body (110) is equipped with a card slot (114) for payment purposes, and the front of the casing main body (110) is fitted with a bar-shaped seat (115) finished with cushions to allow users to sit comfortably.

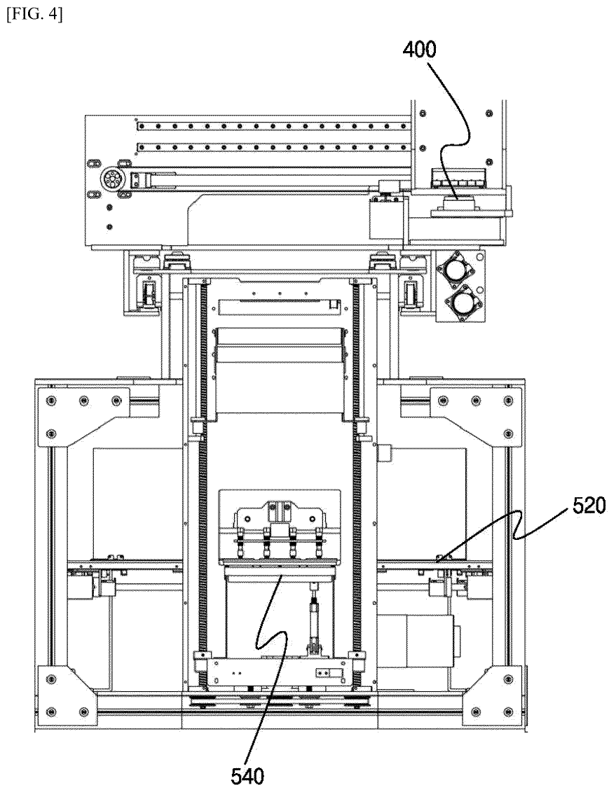

The attached FIG. 3 shows an exploded view of the main components inside the automatic vending device for nail art treatment according to the present invention. FIG. 4 is a front view of FIG. 3, showing the connection relationships between the finger fixture (200), nail measurement means (300), nail art printing means (400), and the loading means.

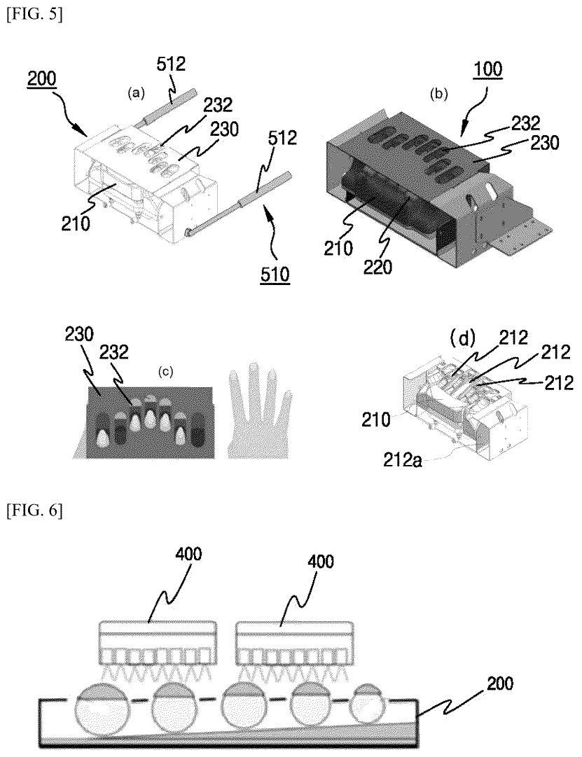

The attached FIGS. 5(a), (b), (c), and (d) illustrate only the finger fixture of the automatic vending device for nail art treatment according to the present invention, showing its appearance and operational states, respectively. FIG. 6 is a schematic diagram showing the state where ink is directly sprayed and printed onto the nail portion of the user's finger positioned in the finger fixture from the printer.

As shown, the finger fixture (200) is designed to allow the fingers of the person undergoing the treatment to be directly placed for nail art application. It is preferably installed inside the casing main body (110) in correspondence with the hand insertion port (112) provided in the casing main body. This configuration allows the fingers of the person undergoing the treatment, inserted through the hand insertion port (112), to be directly placed onto the fixture.

The finger fixture (200) preferably includes the following components:

### Finger Rest (210):

Equipped with multiple finger rest grooves (212), allowing the fingers of the person undergoing the treatment to be individually placed.

### Tube-Type Finger Stabilizer (220):

Installed within the finger rest grooves (212).

Expands with air pressure to securely hold the fingers of the person undergoing the treatment in place within the grooves, preventing movement.

### Support Cover (230):

Installed to cover the top of the finger rest (210).

Prevents the fingers placed in the finger rest grooves (212) from coming into contact with the nozzle area of the nail art printing means.

Includes open slots (232) corresponding to the finger rest grooves (212), which expose only the nails of the fingers to the nozzle area of the nail art printing means.

This configuration ensures stability, precision, and safety during the nail art application process.

At this point, the finger rest grooves (212) should preferably be configured to accommodate and secure at least five fingers-thumb, index finger, middle finger, ring finger, and pinky finger-allowing each finger to be placed and fixed.

Specifically, it is preferable to form the grooves symmetrically, with the middle finger placement groove at the center, flanked on either side by three finger placement grooves and a hand support hole (212a) for inserting and supporting the hand.

For example:

The middle finger of the left hand is placed in the central middle finger placement groove.

The ring finger and pinky finger are placed in the left-side grooves, while the index finger is placed in the right-side groove.

The right hand is inserted into the hand support hole (212a), and the thumb of the right hand is placed in the remaining groove to the right of the middle finger placement groove.

Printing is then performed simultaneously on the index, ring, and pinky fingers of the left hand and the thumb of the right hand.

Subsequently, the process can be reversed to print on the thumb, index, ring, and pinky fingers of the right hand and the thumb of the left hand.

This configuration accommodates the difference in finger lengths between the thumb and other fingers of a single hand, enabling efficient nail art application on four fingers of one hand (excluding the thumb) and the thumb of the other hand simultaneously.

Additionally, the tube-type finger stabilizer (220) includes tubes installed on both sides of the finger rest grooves (212) to secure the fingers placed in the grooves. These tubes expand, driven by an air compressor (not shown), to fix the fingers in place. This configuration utilizes commonly used technology, such as that employed in massage devices to secure legs or arms.

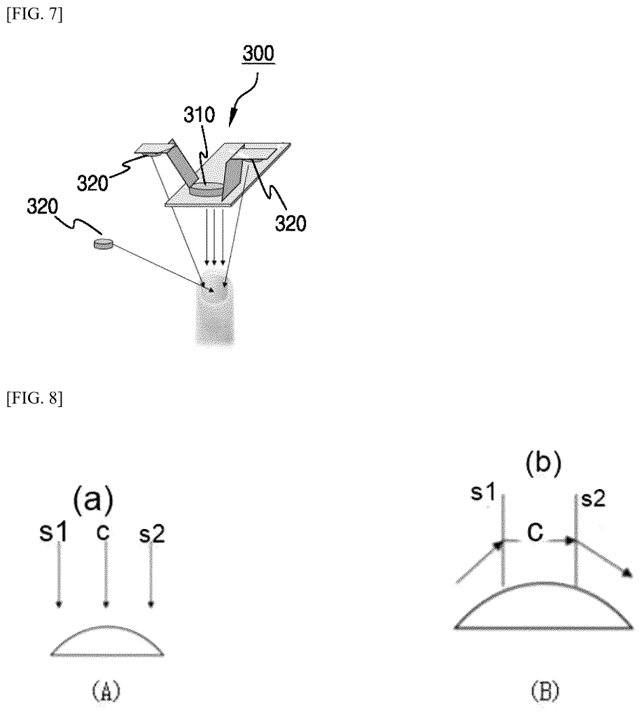

The attached FIG. 7 illustrates an example of use for the nail measurement means included in the automatic vending device for nail art treatment according to the present invention.

As shown, the nail measurement means (300) is installed inside the casing main body (110) above the finger fixture (200). When the user's fingers are placed in the finger fixture (200), the nail measurement means (300) captures image data of each nail by photographing the nail areas of the fingers. This setup is preferable for extracting precise image data of the nails.

The nail measurement means (300) is preferably configured with a camera (310) installed above the finger fixture (200) and multiple lighting lamps (320) to accurately recognize the contours of the user's nails for precise nail measurement.

When the camera (310) captures and recognizes the nails, shadows created by the lighting lamps (320) can make it difficult to identify the precise boundary between the hand and the nails. To address this issue, it is preferable to arrange the lighting lamps (320) in different positions and operate them sequentially. Specifically, when the camera (310) photographs the nails with light coming from a single direction, shadows on the opposite side can obscure the precise boundary between the hand and the nails. To resolve this, it is preferable to position the lighting lamps (320) at multiple locations and operate them sequentially. By synthesizing the images captured under different lighting conditions, the exact boundary between the hand and the nails can be accurately distinguished.

Furthermore, the nail measurement means (300) is preferably implemented using an Al algorithm and is equipped with a nail art image synthesis program capable of storing a vast array of nail art images.

Therefore, it is preferable that the nail art image synthesis program selects the image most similar to the one extracted by the nail measurement means (300) from pre-stored nail images in the database using an Al algorithm. This program synthesizes the selected image with a nail art image to be directly applied to the nails.

Specifically, when the user's hand moves under the camera (310) of the nail measurement means (300), it is measured by the lighting lamps (320) and the camera (310), and nail image data is extracted. The extracted image is then compared with pre-input nail images in the nail art image synthesis program. The program selects the most similar image, synthesizes it with a nail art image, and prepares for printing the combined image onto the user's corresponding nail. The attached FIGS. 8(a) and (b) schematically show the direction in which ink is sprayed onto the user's nails by the nail art printing means included in the automatic vending device for nail art treatment according to the present invention.

As shown, it is preferable that the nail art printing means (400) prints the nail art synthesis image data provided by the nail measurement means (300) directly onto the user's nails for treatment.

Additionally, the nail art printing means (400) is preferably configured to print on nail tips (12) or nail stickers (14) intended for attachment to the user's nails, rather than direct application. Specifically, it is desirable to print the selected nail art image data onto the surface of the nail tips (12) or nail stickers (14) supplied by the loading means.

At this point, it is preferable that the nail art printing means (400) includes a UV printer. The UV printer sprays ink in the direction of the nails from above.

For nail stickers (14), which are flat, this does not pose an issue. However, the user's nail tips (artificial nails) or the nails being treated have curved surfaces, meaning there is a height difference between the central part (c) and the side parts (s1, s2).

In such cases, the printing results show that the central part (c) produces a dark and vivid image, while the side parts (s1, s2) result in faded images.

To resolve this, conventional printer software can be utilized to adjust the printer's movement speed.

At the central part (c), the printer operates at its normal movement speed.

At the side parts (s1, s2), the movement speed is reduced compared to the central part (c), allowing more ink to be sprayed.

This adjustment ensures that the side parts (s1, s2) receive an adequate amount of ink, producing clear and vivid printing results across the curved nail surface.

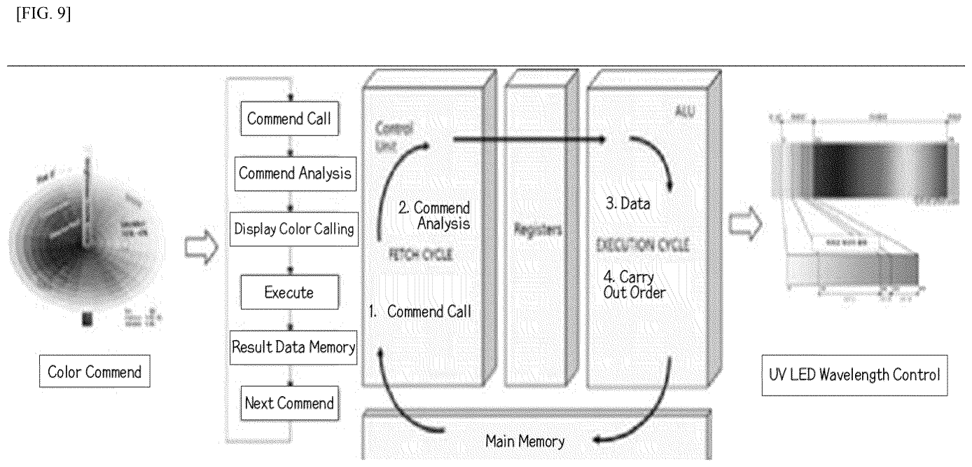

The attached FIG. 9 illustrates the UV LED wavelength control of the nail art printing device in the automatic vending machine for nail art treatment according to the present invention.

The UV printer of the nail art printing means (400) preferably uses UV inks with different UV light wavelengths, such as color ink, white ink, and varnish, and prints at least three times on the user's nails (nail tips or nail stickers). This ensures the creation of clear and vivid nail art images.

Each ink used in the nail art printing means (400) emits UV light with a wavelength necessary for curing, allowing for rapid solidification.

The UV ink used in the nail art printing means (400) is harmless to the human body and is designed with different UV light wavelengths for curing each color.

Utilizing these tailored wavelengths ensures the quick curing of the ink, enhancing efficiency and print quality.

Therefore, it is preferable that the present invention enables the nail measurement camera to recognize colors, analyze and interpret the recognized data, and send the corresponding data to produce UV light with the appropriate wavelength. This UV light wavelength facilitates the curing process.

As shown, the loading means is preferably configured to:

Load the finger fixture (200) so that the nail art printing means (400) can print directly onto the user's nails.

Alternatively, load nail tips (12) or nail stickers (14) for printing nail art images, which are then attached to the user's nails, rather than direct application.

This dual functionality allows for flexible operation, depending on the user's desired method of nail art application.

Therefore, it is preferable that the loading means of the present invention includes a finger rest loading means (510), a nail tip loading means (520), and a nail sticker loading means (530).

The present invention is designed so that only one of the fingernails, nail tips (12), or nail stickers (14) is loaded via a selected loading means among the finger rest loading means (510), nail tip loading means (520), and nail sticker loading means (530). This enables the nail art printing means (400) to either directly apply nail art to the user's nails or print the nail art onto nail tips (12) or nail stickers (14) for subsequent attachment to the user's nails.

As shown, the finger rest loading means (510) is preferably configured to load the finger rest (210), which is part of the finger fixture (200), so that the nail portion of the finger placed on the finger fixture (200) is positioned beneath the nail art printing means (400) for direct nail art application by the printer.

The finger rest loading means (510) preferably includes air cylinders (512) installed on both sides of the finger rest (210) to move it into position beneath the nail art printing means (400) (see FIG. 5(a)).

Thus, by the extension operation of the air cylinders (512), the finger fixture (200) is moved beneath the nail art printing means (400), enabling the printing process for nail art application.

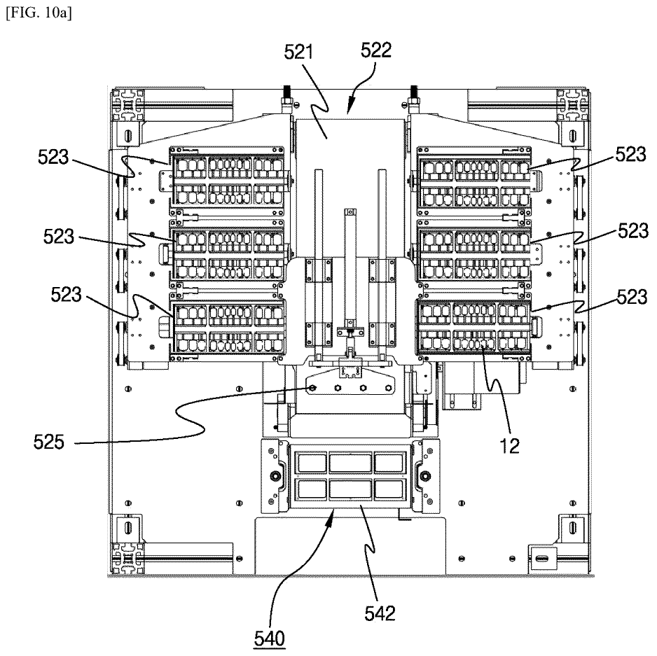

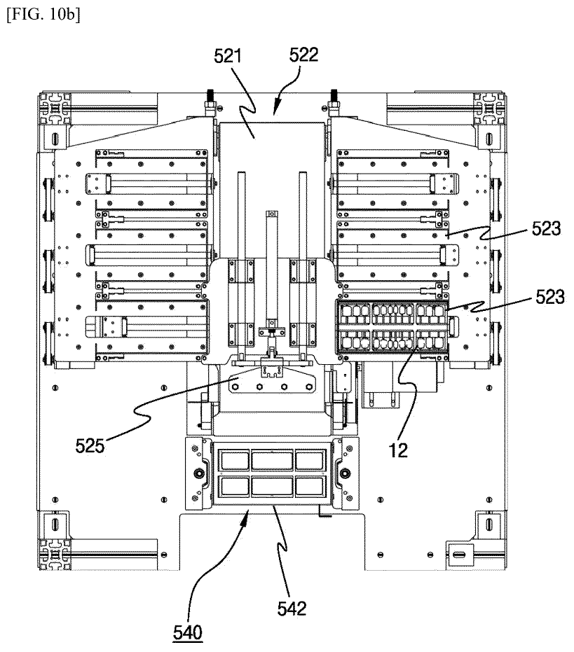

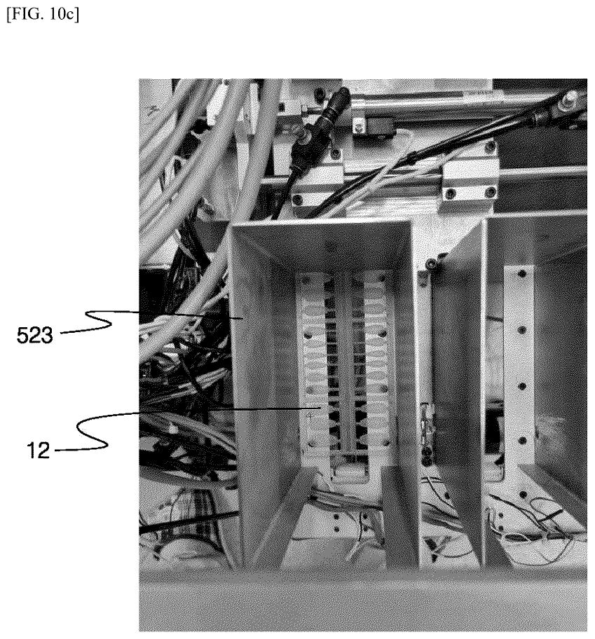

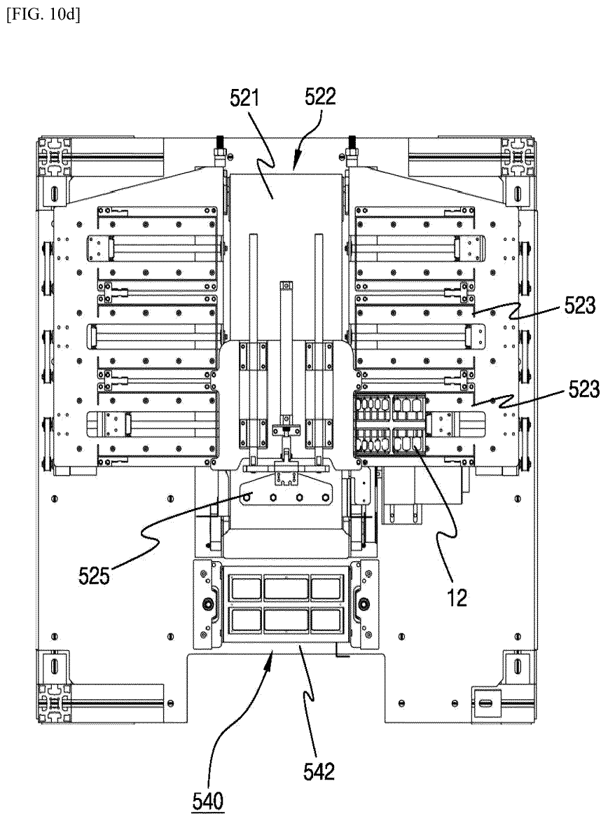

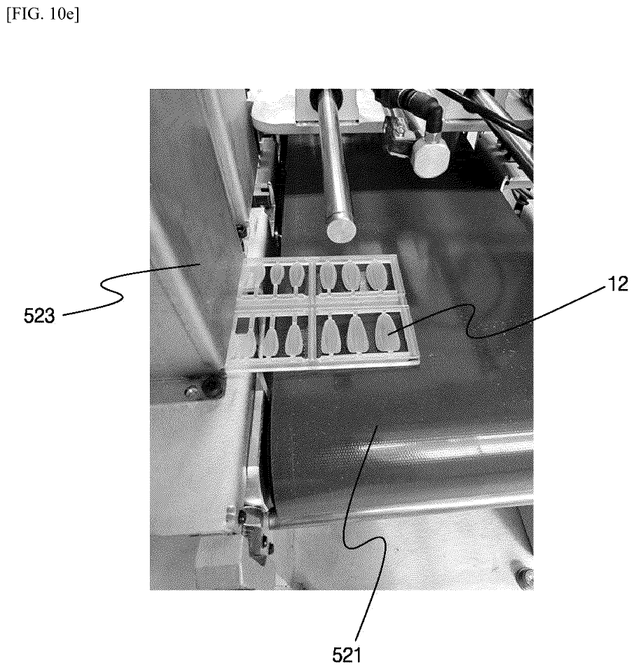

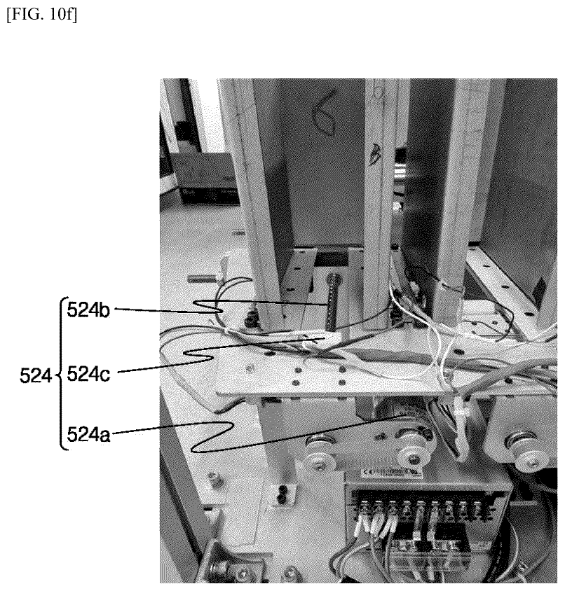

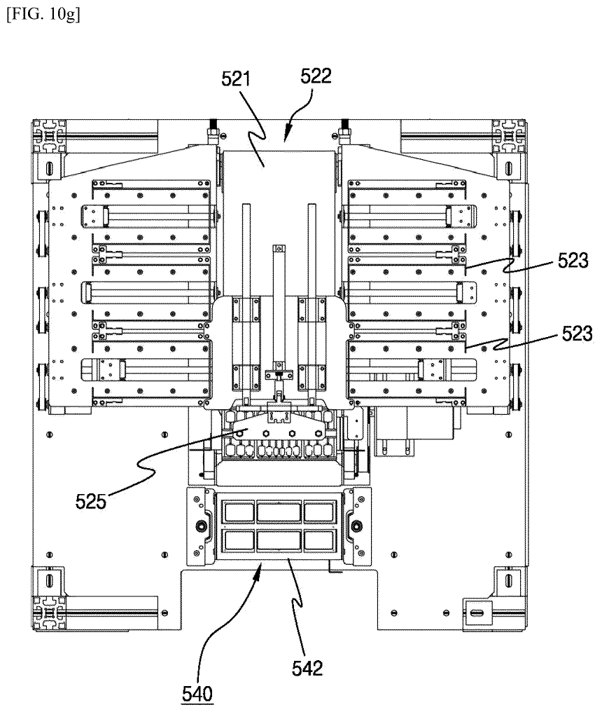

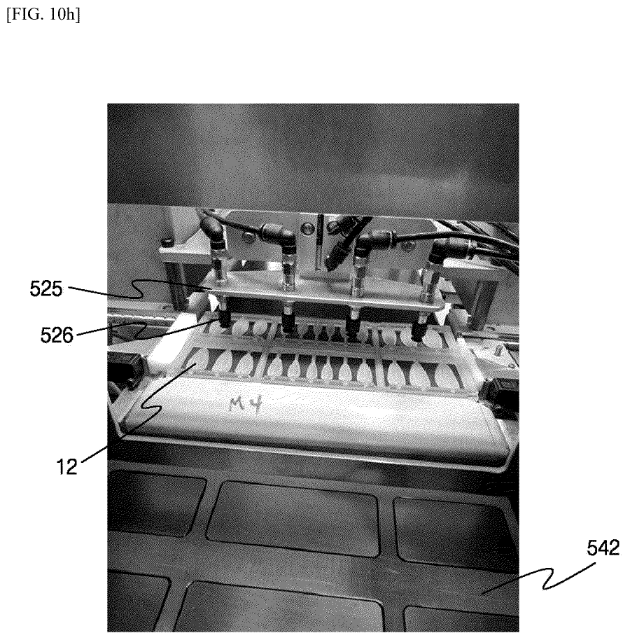

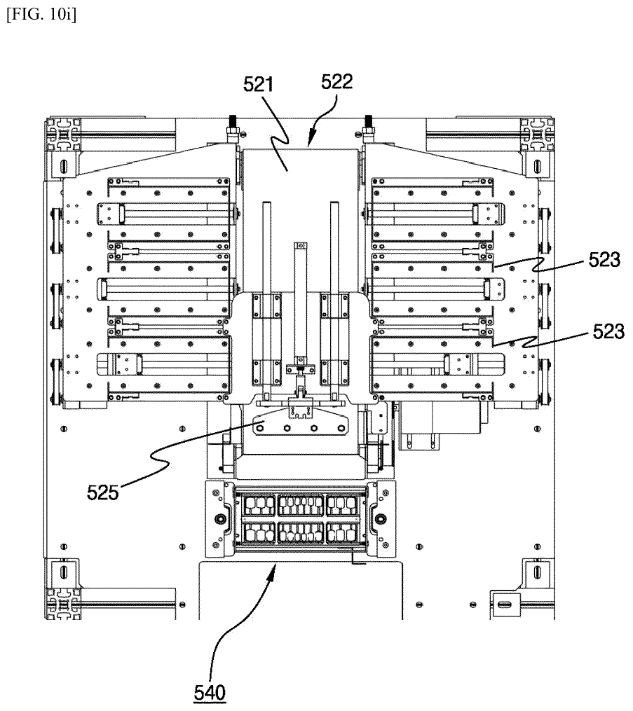

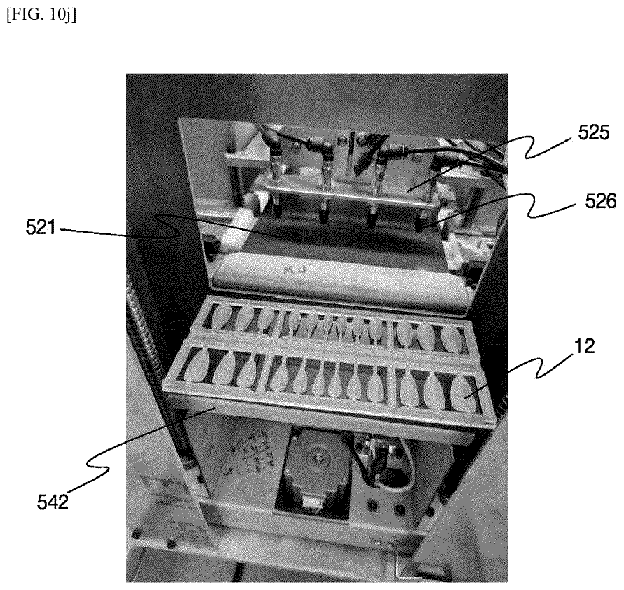

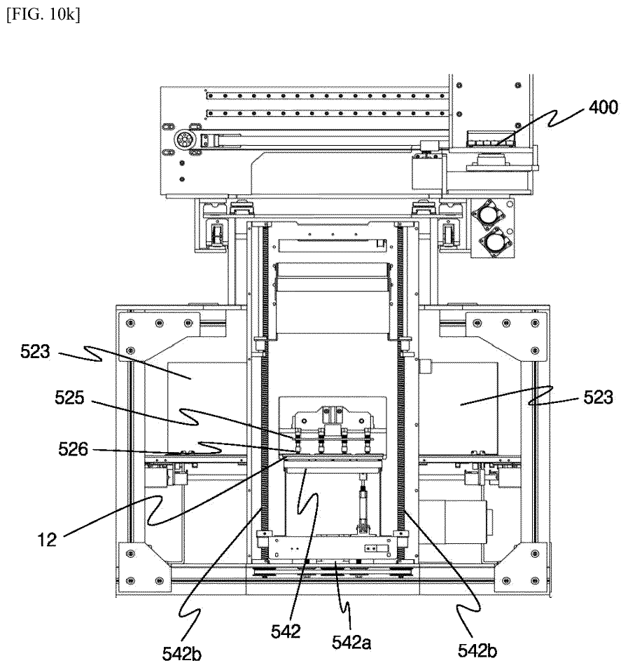

The attached FIG. 10A to FIG. 10L sequentially illustrate the operation process of the nail tip loading means included in the automatic vending device for nail art treatment according to the present invention:

FIG. 10A: A top view showing the state where multiple nail tip stacking units in the nail tip loading means are each loaded with nail tips.

FIG. 10B: A top view showing the state where only the lower nail tip stacking unit is loaded with nail tips, as seen in FIG. 10A.

FIG. 10C: A photo showing the nail tip stacking unit loaded with nail tips, as indicated in FIG. 10B.

FIG. 10D: A top view showing the state where nail tips loaded in the nail tip stacking unit, as shown in FIG. 10B, are being transferred to the conveyor belt.

FIG. 10E: A photo showing the state of nail tips being transferred to the conveyor belt, as indicated in FIG. 10D.

FIG. 10F: A photo showing the motor and ball screw used to transfer the nail tips from the stacking unit to the conveyor belt, as indicated in FIG. 10D.

FIG. 10G: A top view showing the state where nail tips are transferred toward the loading unit via the conveyor belt.

FIG. 10H: A photo showing the state where nail tips are transferred toward the loading unit by the conveyor belt, as shown in FIG. 10G.

FIG. 10I: A top view showing the state where nail tips are transported to the loading unit by the nail tip transport unit, as indicated in FIG. 10G.

FIG. 10J: A photo showing the state where nail tips are transported to the loading unit, as shown in FIG. 10I.

FIG. 10K: A front view of the state where nail tips are transported to the loading unit, as indicated in FIG. 10I.

FIG. 10L: A view showing the raised state of the loading unit, as indicated in FIG. 10K.

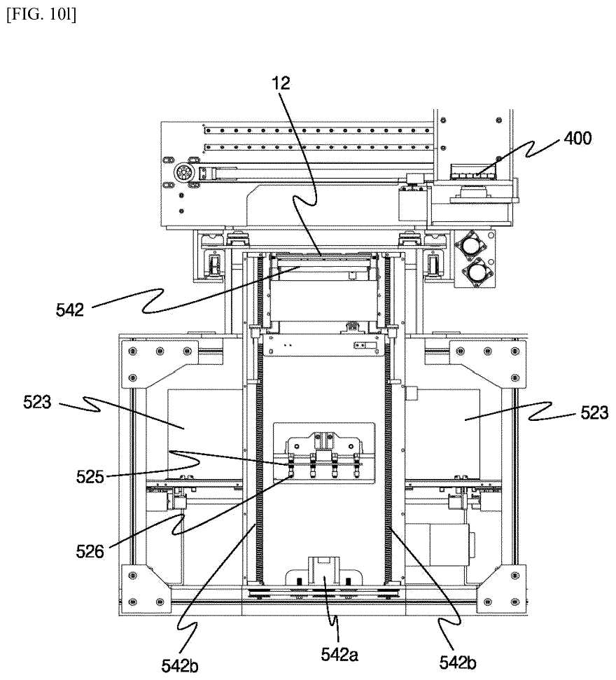

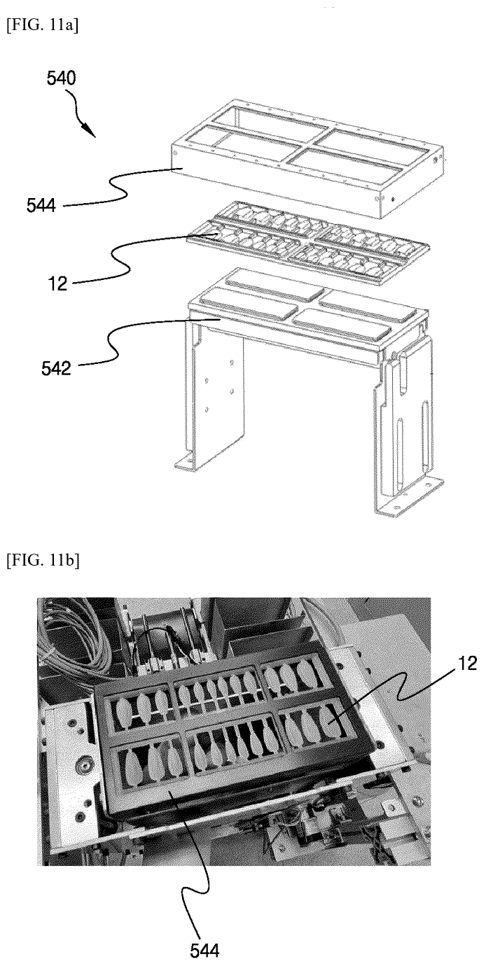

Additionally, FIG. 11a and FIG. 11b illustrate only the loading unit and upper support member of the nail tip loading means included in the automatic vending device for nail art treatment according to the present invention.

As shown, the nail tip loading means (520) is preferably configured to supply nail tips (12) stacked inside the casing main body (110) to the underside of the nail art printing means (400) for printing nail art onto nail tips (12) intended for attachment to the user's nails.

The nail tip loading means (520) includes a loader unit (540) installed to move vertically under the nail art printing means (400). At the lowered position of the loader unit (540), a conveyor belt (521) is installed adjacent to the loader unit (540). A nail tip transport unit (522) is provided to transfer the nail tips (12) supplied by the conveyor belt (521) toward the loader unit (540).

On both sides of the conveyor belt (521), nail tip stacking units (523) are preferably installed to hold the nail tips (12). It is desirable to have multiple stacking units (523), with three on each side of the conveyor belt (521), for a total of six stacking units.

Underneath the nail tip stacking units (523), a nail tip supply unit (524) is installed to sequentially supply nail tips (12) from the stacking units (523) to the conveyor belt (521) from the bottom.

The nail tip supply unit (524) preferably includes:

A motor (524a).

A ball screw (524b) installed to move reciprocally by its rotation.

A supply piece (524c) attached to the ball screw (524b), which pushes and supplies the nail tips.

Specifically:

The ball screw (524b) is installed beneath the nail tip stacking units (523) toward the conveyor belt (521).

The supply piece (524c) is coupled to the ball screw (524b).

The ball screw (524b) is driven by the motor (524a), enabling nail tips (12) stacked in the nail tip stacking units (523) to be sequentially supplied from the bottom to the conveyor belt (521).

Furthermore, nail tips supplied to the conveyor belt (521) by the nail tip supply unit (524) are transported toward the loader unit (540) by the conveyor belt (521). A nail tip transport unit (525) is installed to carry the nail tips (12) transferred by the conveyor belt (521) to the loader unit (540).

The nail tip transport unit (525) preferably includes a suction pad (526) designed to lift nail tips (12) by air pressure and place them onto the loader unit (540). The suction pad (526) moves vertically and reciprocates between the loader unit (540) and the conveyor belt (521), enabling the transport of nail tips (12) from the conveyor belt (521) to the loader unit (540).

It is desirable that the suction pad (526) is installed with the capability for vertical and reciprocal movement, driven by mechanisms such as a vertical movement cylinder and a reciprocating cylinder.

Once transported to the loader unit (540) by the nail tip transport unit (525), the nail tips (12) are moved vertically by the loader unit (540) to the underside of the nail art printing means (400). The loader unit (540) preferably includes a lifting plate (542), which is vertically movable to elevate the nail tips (12) transported by the nail tip transport unit (525).

The lifting plate (542) is preferably driven by:

A motor (542a) installed at the bottom.

Ball screws (542b) vertically positioned on both sides of the lifting plate (542).

These ball screws are driven by the motor (542a) via a belt to rotate in place and enable the lifting plate (542) to move up and down.

Alternatively, cylinders can be installed on both sides of the lifting plate (542) to enable vertical movement.

The top of the lifting plate (542) is preferably equipped with a nail tip upper support member (544), installed at a certain distance below the nail art printing means (400). This support member moves with the lifting plate (542) to provide support for the upper edges of the nail tips during the printing process.

Furthermore, the lifting plate (542) is designed to rotate at a predetermined angle to facilitate the discharge of printed nail tips (12). A rotational axis is installed at the rear of the lifting plate (542), allowing it to rotate and align with the discharge port (113) of the casing main body (110). This ensures that the printed nail tips (12) can be discharged through the discharge port (113) efficiently.

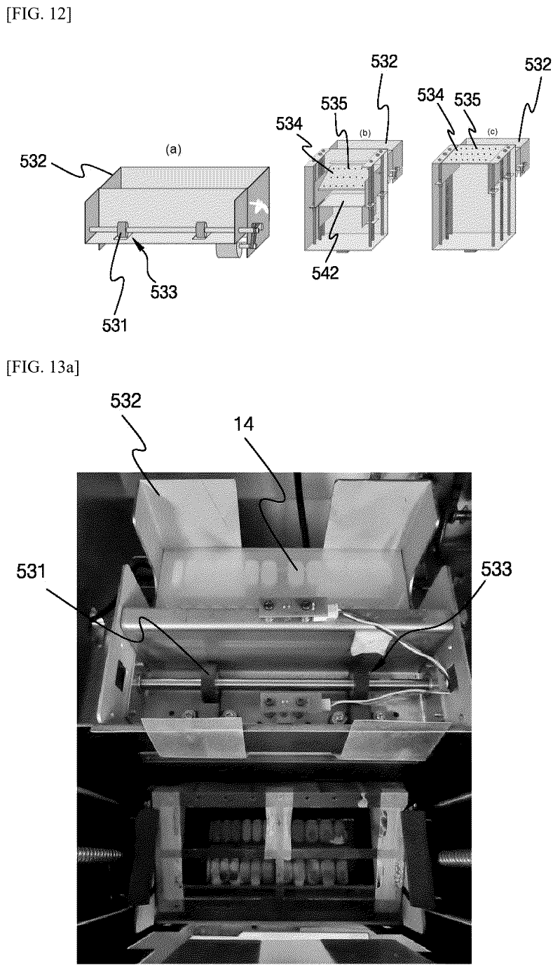

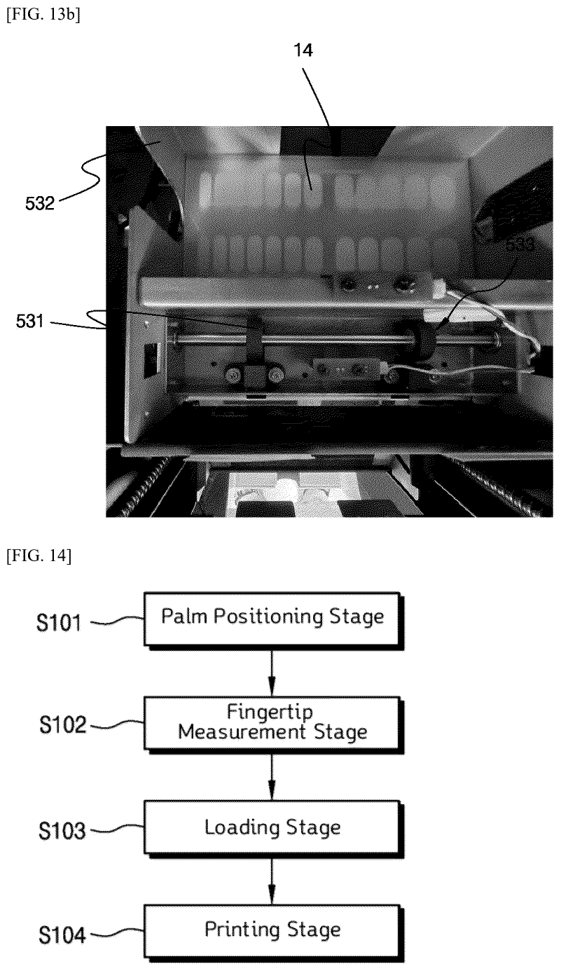

The attached FIGS. 12(a), (b), and (c) illustrate the nail sticker loading means (530) included in the automatic vending device for nail art treatment according to the present invention, while FIG. 13a to FIG. 13b are photos showing the nail sticker loading means from above.

As shown, the nail sticker loading means (530) is preferably configured to sequentially supply nail stickers (14), stacked inside the casing main body (110), to the underside of the nail art printing means (400). This enables the printing of nail art onto nail stickers (14), which can then be attached to the user's nails.

The nail sticker loading means (530) includes a loader unit (540) installed beneath the nail art printing means (400) for vertical movement. At the upper rear of the loader unit (540), a nail sticker stacking unit (532) is installed to hold the stacked nail stickers (14).

Here, the loader unit (540) is the same loader unit described in the nail tip loading means (520) above, ensuring compatibility and efficient operation across both loading systems.

Additionally, the nail sticker stacking unit (532) should preferably be equipped with a nail sticker supply unit (533) to sequentially supply the stacked nail stickers (14) from the bottom.

The nail sticker supply unit (533) is preferably configured with a roller (531) installed beneath the stacking unit. The friction of the roller (531) enables the nail stickers (14) to be supplied one by one. The roller (531) is ideally designed with half of its surface made from a rubber material and the other half from a smooth plastic material. This ensures that only one sticker is accurately pushed and supplied at a time.

Furthermore, it is preferable to install a nail sticker support plate (534) where the nail stickers (14) supplied by the supply unit (533) are placed. The nail sticker support plate (534) is preferably coupled to a rotational axis at the rear, allowing it to rotate by a predetermined angle. When printing is performed on the nail sticker by the nail art printing means (400), the nail sticker support plate (534) should remain in a horizontal position to ensure stable and accurate printing.

The nail sticker support plate (534) is preferably designed to remain in a vertical position when the loader unit (540) is moving vertically due to the operation of the nail tip loading means (520). This prevents any interference with the vertical movement of the loader unit (540).

When the loader unit (540) is operated by the nail sticker loading means (530), the nail sticker support plate (534) is preferably rotated into a horizontal position, allowing it to move vertically together with the loader unit (540).

Specifically:

When nail tips (12) are being loaded, the nail sticker support plate (534) remains in the vertical position to avoid interfering with the vertical movement of the lifting plate (542).

When nail stickers (14) are being loaded, the nail sticker support plate (534) rotates into a horizontal position, enabling the nail stickers to be placed securely on the support plate.

At this time, while the nail sticker support plate (534) is in the horizontal position, the nail sticker supply unit (533) operates to supply nail stickers from the nail sticker stacking unit (532) to the nail sticker support plate (534), ensuring proper placement of the nail stickers for subsequent processing.

Additionally, the nail sticker support plate (534) should preferably have suction holes (535) formed on its surface to hold the nail stickers securely using vacuum pressure. These suction holes (535) ensure that the nail stickers (14) remain fixed on the nail sticker support plate (534) without any movement, enabling precise printing by the nail art printing means (400).

Meanwhile, the loader unit (540) is configured with a lifting plate (542) that moves vertically to support the underside of the nail sticker support plate (534). The lifting plate (542) is preferably coupled to a rotational axis at the rear, allowing it to rotate along with the nail sticker support plate (534) by a specified angle. This setup enables printed nail stickers (14) to be discharged through the discharge port (113) of the casing main body (110) after the printing process.

The attached FIG. 14 is a block diagram illustrating the automatic vending method for nail art treatment according to the present invention.

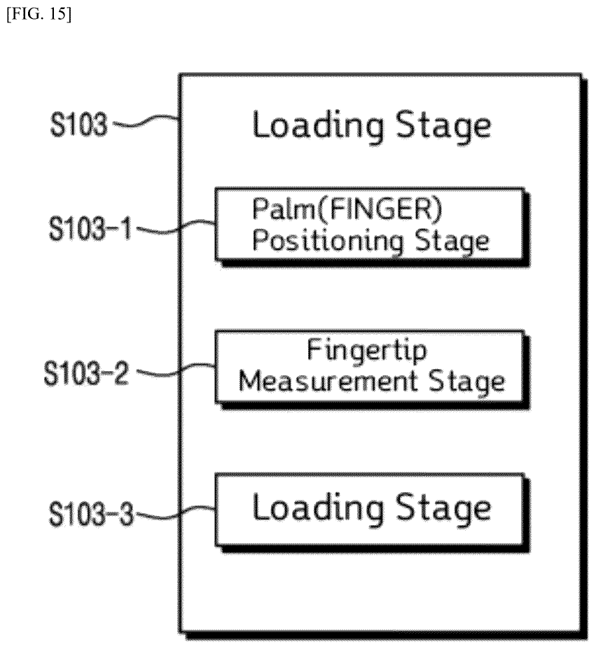

FIG. 15 is a block diagram of the loading step as shown in FIG. 14.

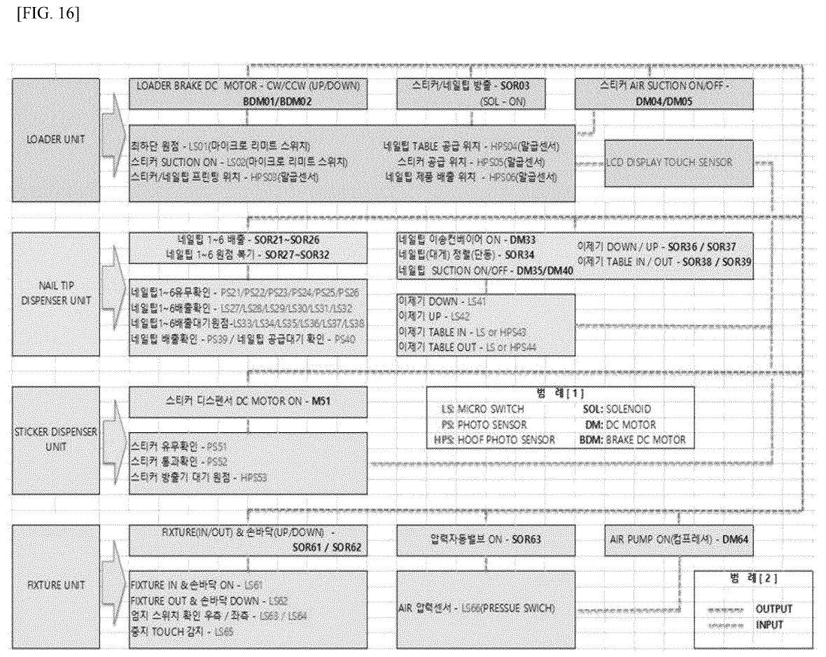

FIG. 16 is another block diagram illustrating the automatic vending method for nail art treatment according to the present invention.

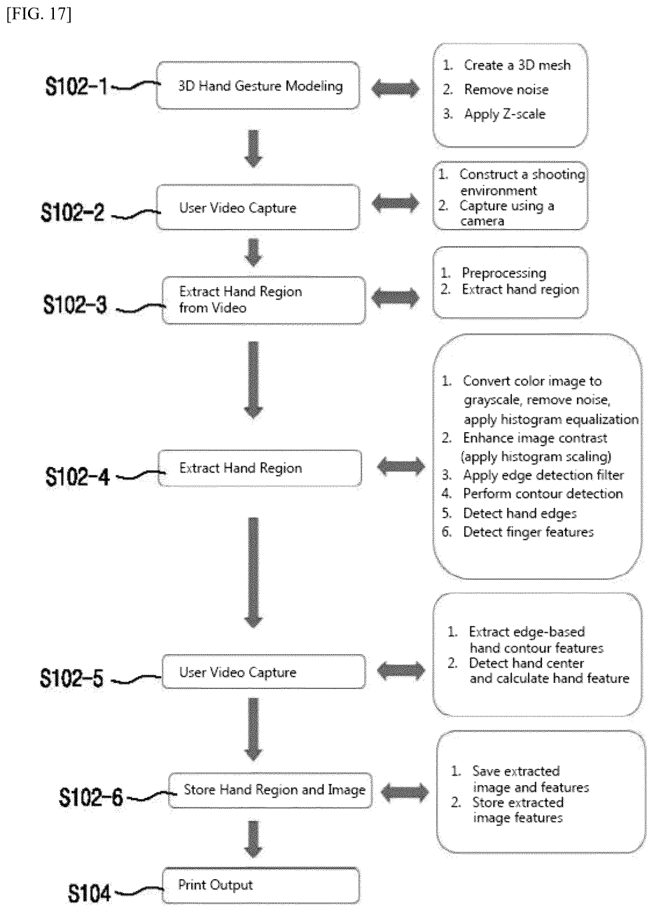

FIG. 17 is a process flow diagram showing the steps for applying desired patterns or designs to the nails of the user using the automatic vending device for nail art treatment according to the present invention.

As shown, the automatic vending method for nail art treatment according to the present invention preferably includes the following steps:

### Finger Placement Step (S101):

Placing the fingers of the user undergoing treatment into the finger fixture (200) through the hand insertion port (112) provided in the casing main body (110) for direct nail art application.

### Nail Measurement Step (S102):

Capturing the nail areas of the user's fingers using the nail measurement means (300) when the fingers are positioned in the finger fixture (200). This step extracts image data for each nail.

### Loading Step (S103):

Loading the finger fixture (200) to enable direct nail art application to the user's nails using the nail art printing means (400).

Alternatively, loading nail tips (12) or nail stickers (14) for printing nail art that will later be attached to the user's nails.

### Printing Step (S104):

Using the nail art printing means (400) to:

Directly print the synthesized nail art image data (from the nail measurement means) onto the user's nails.

Alternatively, print selected nail art image data onto the surfaces of the nail tips (12) or nail stickers (14) supplied during the loading step.

### Detailed Loading Steps (S103):

### Finger Rest Loading Step (S103-1):

Loading the finger rest of the finger fixture (200) so that the nail areas are positioned beneath the nail art printing means (400) for direct application to the user's nails.

### Nail Tip Loading Step (S103-2):

Supplying stacked nail tips inside the casing main body (110) to the underside of the nail art printing means (400) for printing.

### Nail Sticker Loading Step (S103-3):

Sequentially supplying stacked nail stickers inside the casing main body (110) to the underside of the nail art printing means (400) for printing.

### Operation:

The method preferably involves performing only one of the loading steps—finger rest loading (S103-1), nail tip loading (S103-2), or nail sticker loading (S103-3)—based on the intended application. This ensures that during the printing step (S104), the system either applies nail art directly to the user's nails or prints onto nail tips or nail stickers for attachment to the user's nails.

Additionally, the nail measurement step (S102) performed by the nail measurement means (300) preferably includes the following sub-steps:

### Step 1 (S102-1): Scanning

Scanning the fingers of the user placed in the finger fixture using a 3D scanner.

### Step 2 (S102-2): Image Capture

After scanning, obtaining hand images of the user via the nail measurement means.

### Step 3 (S102-3): Background Removal and Finger Area Extraction

Removing the background from the captured images and extracting the finger area using algorithms and guides.

### Step 4 (S102-4): Nail Position Information Extraction

Extracting position information for the nails from the identified finger areas.

### Step 5 (S102-5): Candidate Nail Area Setting

Based on the extracted nail position information, setting candidate areas for nail art application.

### Step 6 (S102-6): Nail Art Image Alignment

Aligning the user-selected, pre-stored image or a user-created nail art image to the candidate nail areas using the extracted nail information.

The selected nail art image data is then transmitted to the nail art printing means for application. This allows the image to be directly printed onto the user's candidate nail areas or onto nail tips or nail stickers for later attachment. At this point, in Step 1 (S102-1), scanning with the 3D scanner is preferably performed through the following processes:

3D Mesh Generation: Creating a 3D mesh of the scanned fingers.

Error Correction: Fixing errors in the generated mesh.

Z-Value Scale Adjustment: Calibrating and correcting the Z-axis scale values for precision.

Additionally, in Step 4 (S102-4) (Nail Position Information Extraction) and Step 5 (S102-5) (Candidate Nail Area Setting), the processes involve:

Selecting a candidate group of nails through area matching with a database of hand images.

Noise Removal: Eliminating irrelevant or interfering data.

Model Selection and Training: Developing models for identifying nail areas.

Cross-Validation: Evaluating the models through cross-validation.

Model Fine-Tuning: Adjusting the models to improve accuracy and precision in extracting nail position information.

In Step 6 (S102-6), image alignment for the candidate nail areas is preferably executed using an Al-based nail art image synthesis program. This program:

Extracts nail images from the user's data.

Matches these images with pre-stored nail images in the database using the Al algorithm.

Selects the most similar nail image from the database.

Synthesizes the selected nail image with the nail art image to be directly applied to the user's nails.

This method ensures precise and personalized nail art application based on the user's specific nail data.

The method for nail art treatment according to the present invention is described as follows:

First, the user selects whether to directly apply nail art to their nails or to print the nail art onto nail tips or nail stickers. Following the selection, the fingers for nail art application are positioned onto the finger fixture (200) through the hand insertion port (112) provided in the casing main body (110).

Once the user's fingers are placed on the finger fixture (200), the nail measurement means (300) captures images of the nail areas of the user's fingers to extract image data for each nail.

At this stage, the nail measurement means (300) performs imaging by scanning the user's fingers positioned on the finger fixture with a 3D scanner. The scanning process involves:

Generating a 3D Mesh of the scanned fingers.

Correcting Errors in the generated mesh.

Adjusting Z-Value Scales for precise measurement and calibration.

After scanning is completed, the nail measurement means begins capturing images of the user's hands. During this process, background removal is performed, the finger areas are extracted from the captured images, and nail position information is extracted from the identified finger areas.

The extraction of nail position information involves:

Selecting candidate nail regions through area matching with a hand image database.

Noise removal from the selected regions.

Model selection and training for identifying nail regions.

Evaluation through cross-validation of the model.

Fine-tuning the model to improve accuracy and precision in extracting nail position information.

Based on the extracted nail position information, candidate regions for nail art application are set. The user's selected pre-stored image or a custom-designed nail art image is then aligned to the candidate nail regions using a nail art image synthesis program.

The alignment of the image to the candidate nail regions is performed by the Al-based nail art image synthesis program. This program compares the extracted nail images with pre-input nail images stored in the database using the Al algorithm. The program selects the most similar nail image from the database and synthesizes it with the chosen nail art image, which is then applied directly to the user's nails.

Through these steps, the selected nail art image data is immediately transmitted to the nail art printing means (400). Using a UV printer, the data is directly printed onto the user's candidate nail areas, completing the treatment process.

If the user selects direct application of nail art during the initial step, the finger rest loading means operates to position the nails under the printing means, allowing the nail art to be directly printed onto the user's nails. Alternatively, if the user selects to print the nail art onto nail tips or nail stickers, the nail tip loading means or nail sticker loading means operates to supply the nail tips or stickers under the nail art printing means. The selected nail art image data is then printed onto the surface of the loaded nail tips or stickers by the nail art printing means (400) and subsequently discharged.

According to the present invention, depending on the user's selection:

The synthesized nail art image data provided by the nail measurement means can be directly printed onto the user's nails, or The data can be printed onto nail tips or nail stickers intended for attachment to the user's nails.

This provides consumers with the ability to enjoy the fun and beauty of nail art. The technical objectives of the present invention are achieved through the above-described technical configurations. While the invention has been described with reference to specific embodiments and drawings, it is not limited to these.

Various modifications and alterations can be made within the scope of the invention by those skilled in the art, as long as they fall within the spirit of the invention and the equivalent scope of the patent claims described below.

### DESCRIPTION OF REFERENCE NUMERALS

110: Casing Main Body
200: Finger Fixture
300: Nail Measurement Means
400: Nail Art Printing Means
510: Finger Rest Loading Means
520: Nail Tip Loading Means
530: Nail Sticker Loading Means

1. An automatic vending device for nail art treatment, comprising:
A casing main body provided with:
A hand insertion port formed to allow the user's hand to be directly inserted for applying nail art directly to the user's nails; and
A discharge port formed to discharge nail tips or nail stickers, printed for attachment to the user's nails rather than direct application.
A finger fixture located inside the casing main body corresponding to the hand insertion port, enabling the user's fingers to be directly positioned through the hand insertion port.
A nail measurement means installed inside the casing main body, positioned above the finger fixture. The nail measurement means captures images of the user's nail areas when the user's fingers are positioned on the finger fixture, extracting image data for each nail.
A nail art printing means for:
Directly printing the nail art synthesis image data provided by the nail measurement means onto the user's nails; or
Printing the nail art synthesis image data onto nail tips or nail stickers, which are later attached to the user's nails instead of direct application.
A loading means for:
Loading the finger fixture to position the user's nails for direct printing by the nail art printing means; or
Loading nail tips or nail stickers for printing by the nail art printing means, enabling their attachment to the user's nails.
Wherein the device provides functionality for applying nail art directly to the user's nails or printing nail art onto nail tips or nail stickers, characterized by the above features.

2. The automatic vending device for nail art treatment according to claim 1, wherein:
The loading means includes:
A finger rest loading means configured to load a finger rest, which is part of the finger fixture, so that the nail areas of the fingers positioned on the finger fixture are located beneath the nail art printing means, enabling direct printing onto the user's nails.
A nail tip loading means configured to supply stacked nail tips inside the casing main body to the underside of the nail art printing means, allowing nail art to be printed on nail tips intended for attachment to the user's nails.
A nail sticker loading means configured to sequentially supply stacked nail stickers inside the casing main body to the underside of the nail art printing means, allowing nail art to be printed on nail stickers intended for attachment to the user's nails.
Wherein one selected loading means among the finger rest loading means, nail tip loading means, and nail sticker loading means loads only one of the user's nails, nail tips, or nail stickers, and the nail art printing means performs direct nail art application to the user's nails or prints nail art onto nail tips or nail stickers for attachment to the user's nails.

3. The automatic vending device for nail art treatment according to claim 2, wherein:
The finger rest loading means includes air cylinders installed on both sides of the finger rest, which is part of the finger fixture, to position the finger rest beneath the nail art printing means.

4. The automatic vending device for nail art treatment according to claim 2, wherein:
The nail tip loading means includes:
A loader unit installed beneath the nail art printing means, configured to move vertically.
A nail tip transport unit, comprising:
A conveyor belt installed adjacent to the loader unit at its lowered position, to transport nail tips supplied by the conveyor belt toward the loader unit.
Multiple nail tip stacking units installed on both sides of the conveyor belt, for stacking nail tips.
A nail tip supply unit configured to sequentially supply nail tips from the bottom of the nail tip stacking units to the conveyor belt.
A suction pad included in the nail tip transport unit, configured to:
Use air pressure to lift nail tips transported by the conveyor belt.
Place the lifted nail tips onto the loader unit.
Move vertically and reciprocally between the loader unit and conveyor belt, enabling transportation of nail tips from the conveyor belt to the loader unit.
The loader unit includes:
A lifting plate, installed to move vertically, for elevating nail tips transported by the nail tip transport unit. The lifting plate is configured to rotate by a predetermined angle at a rear rotational axis to discharge printed nail tips through the discharge port of the casing main body.
A nail tip upper support member, installed at a certain distance above the lifting plate and beneath the nail art printing means, to support the upper edges of the nail tips during printing.
Wherein these features allow the nail tip loading means to precisely load, transport, and support nail tips for nail art printing and subsequent discharge.

5. The automatic vending device for nail art treatment according to claim 2, wherein:
The nail sticker loading means includes:
A loader unit installed beneath the nail art printing means, configured to move vertically.
A nail sticker stacking unit, installed at the upper rear of the loader unit, for holding stacked nail stickers.
A nail sticker supply unit, configured to sequentially supply nail stickers from the bottom of the nail sticker stacking unit.
A nail sticker support plate, configured to:
Securely hold the nail stickers supplied by the nail sticker supply unit.
Be coupled to a rotational axis at the rear, allowing rotation by a predetermined angle.
Maintain a horizontal position during printing by the nail art printing means.
The loader unit further includes:
A lifting plate, installed to move vertically, for supporting the underside of the nail sticker support plate.
A rotational axis at the rear of the lifting plate, enabling it to rotate by a predetermined angle along with the nail sticker support plate to discharge printed nail stickers through the discharge port of the casing main body.
Wherein these features allow the nail sticker loading means to precisely supply, support, and handle nail stickers for nail art printing and subsequent discharge.

6. The automatic vending device for nail art treatment according to claim 5, wherein:
The nail sticker support plate is provided with suction holes formed to hold and support the nail stickers using vacuum pressure.

7. The automatic vending device for nail art treatment according to claim 1, wherein:
The finger fixture comprises:
A finger rest with multiple finger placement grooves formed to allow each of the user's fingers to be securely placed.
Tube-shaped finger restraints, installed in the finger placement grooves of the finger rest, configured to expand using air pressure to hold the user's fingers securely in place without movement.
A support cover, installed to cover the top of the finger rest, configured to:
Prevent the user's fingers placed in the finger placement grooves from coming into contact with the nozzle area of the nail art printing means.
Include open grooves corresponding to the finger placement grooves, allowing the nails of the user's fingers to be exposed toward the nozzle area of the nail art printing means.

8. The automatic vending device for nail art treatment according to claim 1, wherein:
The nail measurement means comprises:
A camera, installed above the finger fixture, for capturing images of the user's nails.
Multiple lighting lamps, positioned at different locations to reduce shadow interference.
The lighting lamps are configured to operate sequentially, ensuring accurate recognition of the boundaries between the hand and nails during image capture by the camera.

9. The automatic vending device for nail art treatment according to claim 8, wherein:
The nail measurement means includes an Al-based nail art image synthesis program, wherein:
The nail art image synthesis program utilizes an Al algorithm to analyze the images extracted by the nail capturing means.
The program selects the most similar nail image from a pre-stored database of nail images and synthesizes it with the nail art image to be directly applied to the user's nails.

10. The automatic vending device for nail art treatment according to claim 1, wherein:
The nail art printing means uses UV ink with varying UV light wavelengths, including color ink, white ink, and varnish, to print on nail tips, nail stickers, or the user's nails.
The printing process involves at least three layers of printing, with each ink layer cured by emitting UV light at the specific wavelength required for its curing.

11. The automatic vending device for nail art treatment according to claim 10, wherein:
When the printing surface handled by the nail art printing means is curved, the printer adjusts its movement speed to be slower at the curved edges compared to the central part of the curve.
This adjustment ensures increased ink deposition on the sides of the curved surface, achieving consistent and precise printing quality across the entire curved area.

12. A method for automatic vending of nail art treatment, comprising:
Finger Placement Step:
Positioning the user's fingers onto a finger fixture through a hand insertion port provided in the casing main body.
Nail Measurement Step:
Capturing images of the user's nail areas using the nail measurement means to extract image data for each nail when the user's fingers are positioned on the finger fixture.
Loading Step:
Either loading the finger fixture to position the user's nails for direct nail art application using the nail art printing means, or
Loading nail tips or nail stickers for printing nail art images that will later be attached to the user's nails.
Printing Step:
Using the nail art printing means to:
Directly print the nail art synthesis image data provided by the nail measurement means onto the user's nails, or
Print the selected nail art image data onto the surface of nail tips or nail stickers supplied during the loading step.
This method enables precise nail art application or printing for attachment to nails using the automated vending device.

13. The method for automatic vending of nail art treatment according to claim 12, wherein:
The nail measurement step comprises:
Step 1:
Scanning the user's fingers positioned on the finger fixture using a 3D scanner.
Step 2:
Capturing images of the user's hands using the nail measurement means after the scanning is completed.
Step 3:
Removing the background from the captured images and extracting the finger areas using algorithms and guides.
Step 4:
Extracting nail position information from the identified finger areas.
Step 5:
Setting candidate nail regions for nail art application based on the extracted nail position information.
Step 6:
Aligning a pre-stored or user-created nail art image selected by the user with the candidate nail regions using the extracted nail information.
The selected nail art image data is then transmitted to the nail art printing means for direct printing onto the user's candidate nail regions or for printing onto nail tips or nail stickers.

14. The method for automatic vending of nail art treatment according to claim 13, wherein:
In Step 1, scanning with the 3D scanner is performed through the processes of:
Generating a 3D mesh of the scanned fingers,
Correcting errors in the generated mesh, and
Calibrating Z-value scales for precise measurement and accuracy.

15. The method for automatic vending of nail art treatment according to claim 13, wherein:
In Step 4 (nail position information extraction) and Step 5 (candidate nail region setting), nail position information is extracted by:
Selecting a candidate group of nails through area matching with a hand image database,
Performing noise removal,
Selecting and training models,
Evaluating the models through cross-validation, and
Performing fine-tuning of the models for precise extraction of nail position information.

16. The method for automatic vending of nail art treatment according to claim 13, wherein:
In Step 6 (image alignment for candidate nail regions), the alignment is performed by an Al-based nail art image synthesis program, which:
Analyzes the images extracted from the user's nails,
Compares these images with pre-stored nail images in a database using an Al algorithm,
Selects the most similar nail image from the database, and
Synthesizes the selected nail image with the nail art image to be directly applied to the user's nails.

17. The method for automatic vending of nail art treatment according to claim 12, wherein:
The loading step comprises:
A finger rest loading step:
Loading the finger rest of the finger fixture to position the user's nails beneath the nail art printing means for direct nail art application to the user's nails.
A nail tip loading step:
Supplying stacked nail tips from within the casing main body to the underside of the nail art printing means for printing nail art onto nail tips intended for attachment to the user's nails.
A nail sticker loading step:
Sequentially supplying stacked nail stickers from within the casing main body to the underside of the nail art printing means for printing nail art onto nail stickers intended for attachment to the user's nails.
Wherein only one of the steps (finger rest loading, nail tip loading, or nail sticker loading) is performed, and the printing step is executed to either:
Directly apply nail art to the user's nails, or
Print nail art onto nail tips or nail stickers for attachment to the user's nails.
